(19) United States
(12) Patent Application Publication
(10) Pub. No.: US 2014/0164315 A1
(43) Pub. Date: Jun. 12, 2014

(54) System And Method For The Creation Of, Automatic Synchronization Of, And Access To Multi-Cloud Documents That Reside Across Dissimilar Clouds, Devices, And Operating Systems And That Are Accessed By Multiple Dissimilar Applications

(71) Applicant: Ali Golshan, Santa Clara, CA (US)

(72) Inventor: Ali Golshan, Santa Clara, CA (US)

(21) Appl. No.: 13/917,629

(22) Filed: Jun. 13, 2013

Related U.S. Application Data
(60) Provisional application No. 61/659,404, filed on Jun. 13, 2012.

(51) Int. Cl. H04L 29/06; G06F 17/30

(52) U.S. Cl. CPC H04L 65/403; G06F 17/30011
USPC 707/608

(57) ABSTRACT

System and services are described that permit the creation of “multi-cloud documents.” Multiple synchronized copies of a single document may be synchronized across dissimilar clouds, devices (both mobile and stationary), and operating systems. This may be implemented using software on the devices, in conjunction with an intermediate cloud. Multi-cloud documents may also be shared with other uses using dissimilar clouds, devices, or applications. Documents may be locked on a fine-structured level to minimize the possibility of edit collisions.

### CROSS-REFERENCE TO RELATED APPLICATION

This application claims priority to U.S. Provisional Application No. 61/659,404, entitled “System and Method for the Creation of, Automatic Synchronization of, and Access to Multi-Cloud Documents that Reside Across Dissimilar Clouds, Devices, and Operating Systems and that are Accessed by Multiple Dissimilar Applications,” filed 13 Jun. 2012, the entire disclosure of which is hereby incorporated by reference.

### TECHNICAL FIELD

This application relates to the field of computer networking and cloud computing.

### BACKGROUND

The notion of “cloud computing” has become mainstream in recent years. Large data centers that are accessible to almost any computer or mobile device offer unique advantages for storing and sharing information.

Seeing the cloud as a large opportunity to capture customers many companies have been started to focus solely on building large clouds. Many established technology companies have begun to offer cloud services to their users.

Users want to be able to easily store, access, and share documents from all of the devices they use whether they be desktop computers, laptop computers, mobile phones, tablets, TV set top boxes, gaming consoles and other computing devices. The large number of devices, each based on different hardware, running different operating systems, and running different applications, make the task of building cloud services that can share document very challenging.

Many operators of large clouds find it easier—and in many cases more sensible from a business strategy standpoint—to make their cloud operate with only certain types of equipment, or operating systems. The cloud providers often offer their users a “silo”—a cloud that works with a limited number of devices, operating systems or applications. In some cases this eases the cost of operating these clouds, and in many cases makes the use of the clouds by users easier—provided the users mainly use devices of the type that the cloud operator wants them to.

Siloed clouds, however, present several challenges to users. First, users that happen to own a variety of devices, not all of which work in any single cloud, face real challenges sharing files between the devices. Second, even if a user happens to own devices that all share the same cloud, that user will face challenges to sharing his or her information with colleagues whose device operate best with a different cloud. Third, even a user that has devices that all operate within a single cloud may have multiple applications that run on those devices and not all of those applications may work with the single cloud they have decided to use.

Users can “solve” the above problems by connecting to multiple clouds, using multiple applications, or even carrying multiple devices. This adds enormous complexity to the user's use of their devices, applications, and clouds and if the user has numerous documents that she is sharing in the cloud the process of maintaining all of the relationships between devices, applications, documents and clouds becomes unwieldy.

Example of clouds in operation include GoogleDrive by Google, iCloud by Apple, SkyDrive from Microsoft, DropBox from DropBox, Inc, Box from Box, Inc. and many others. A few examples of applications that restrict which clouds they can operate with include GoogleDocs from Google and iWork from Apple.

Attempts to somehow “unite” the various cloud “silos” are very difficult for a variety of reasons. First, in many cases cloud operators do not want their clouds to interoperate with other clouds or with devices, operating systems, or applications that the cloud operator does not control or with whom the cloud operator does not have appropriate business relationships. Second, in many cases, cloud operators do not allow applications other than the ones that they approve to be able to write to documents stored in their clouds. This “cloud write” restriction makes it extremely hard for a “cross cloud” application to be written that can bridge the gap between clouds. Third, if the “cloud write” restrictions did not exist, schemes that have been proposed for sharing between clouds, devices, and applications have proven to be extremely complex involving elaborate token passing systems that are a challenge to implement. Finally, differences in document and file formats between different similar applications offered by different vendors have proven a challenge to synchronize. While many companies are able to translate file formats between different applications some of the new applications actually do not even use a file format to save their information but instead save the information in a database or in some format that is opaque to the outside world making format conversion difficult or impossible.

These limitations, and others, have prevented the creation of a system that interconnects dissimilar clouds, applications, documents, and devices in a seamless way that keeps all document synchronized and which allows users to simply edit and share their documents without the need to be aware of arbitrary barriers between these various entities.

Users faced with this problem are forced to share documents by exporting them from one cloud to another every time that they want to edit the documents or send them to a colleague. Another way users move documents to others or even between their own devices is to “self-email” them—email them to their own email account and then use the email account to retrieve the document on the other device. In addition to being inconvenient, self-emailing wastes network bandwidth and email storage. It also can result in an explosion in the number of version of a document that exist making document synchronization very labor intensive.

What is needed is a solution to the problem of interconnection of clouds, applications, documents, and devices in a comprehensive, efficient, scalable, and easy to use manner that is transparent to the user. Also, there is a need to eliminate the requirement for complex token-passing schemes and results in modest transfers of data between clouds and devices thereby reducing the load on network architectures.

### BRIEF SUMMARY

Described herein are embodiments including a method comprising: detecting, within a first computer process in a multitasking environment, one or more first changes in a first data structure stored in a first digital storage medium which is part of a first digital device; wherein the first data structure comprises at least a portion of a first user-editable document corresponding to a multi-cloud document identifier; wherein the one or more first changes are made within a second computer process which is different from the first computer process; and wherein the first digital device further comprises a data transmitter in connection via a network with a mesh cloud server; and sending (A) the multi-cloud document identifier and (B) a first representation of the one or more first changes, to the mesh cloud server via the data transmitter over the network; wherein the mesh cloud server comprises a computer processor, a data receiver configured to receive the first representation, an intermediary digital storage medium, and a database comprising one or more records linking the multi-cloud document to unique identifiers of one or more user-editable documents including the first user-editable document.

In another embodiment, there is described a method comprising: receiving, in a transmission over a network from a first digital device to a mesh cloud server, (A) a multi-cloud document identifier and (B) a first representation of one or more first changes in a first data structure stored in a first digital storage medium which is part of the first digital device, wherein the first data structure comprises at least a portion of a first user-editable document corresponding to the multi-cloud document identifier, and wherein the mesh cloud server comprises: a first database record linking the multi-cloud document identifier to a unique identifier of the first user-editable document; a second database record linking the multi-cloud document identifier to a unique identifier of a second user-editable document; converting the first representation into a second representation of one or more second changes to be made in a second data structure which comprises at least a portion of the second user-editable document; and sending the second representation to a second digital device comprising a second digital storage medium that comprises the second data structure.

Various additional embodiments, including additions and modifications to the above embodiments, are described herein or would be apparent to a person working in this field.

### BRIEF DESCRIPTION OF THE DRAWINGS

The accompanying drawings, which are incorporated into this specification, illustrate one or more exemplary embodiments of the inventions disclosed herein and, together with the detailed description, serve to explain the principles and exemplary implementations of these inventions. One of skill in the art will understand that the drawings are illustrative only, and that what is depicted therein may be adapted, based on this disclosure, in view of the common knowledge within this field.

In the drawings:

FIG. 1 is a diagram illustrating a typical prior art customer multi-cloud configuration.

FIG. 2 is a diagram illustrating an example of a simplified customer multi-cloud configuration, showing the steps of a write operation by a mesh client user.

FIG. 3 is a diagram illustrating an example of a simplified customer multi-cloud configuration, showing the steps of a write operation by a mesh client user where one device is initially turned off.

FIG. 4 is a diagram illustrating an example of a simplified customer multi-cloud configuration, showing the steps of a write operation by an outside user.

FIG. 5 is a diagram illustrating an example of a simplified customer multi-cloud configuration, showing the steps of a write operation with clients that do not require memory injection.

FIG. 6 is a diagram illustrating an example of a process for injecting parameters into an operating system or application function.

FIG. 7 is a diagram illustrating an example of matching and mapping elements of documents between different applications.

FIG. 8 is a diagram illustrating an example of the discovery of the internal data format of an application function.

FIG. 9 is a diagram illustrating an example of memory injection and resulting update to screen or user, cloud, and memory.

### DETAILED DESCRIPTION

Various example embodiments of the present inventions are described herein. Those of ordinary skill in the art will understand that the following detailed description is illustrative only and is not intended to be in any way limiting. Other embodiments of the present inventions will readily suggest themselves to such skilled persons having the benefit of this disclosure, in light of what is known in the relevant arts, the provision and operation of information systems for such use, and other related areas.

Not all of the routine features of the exemplary implementations described herein are shown and described. In the development of any such actual implementation, numerous implementation-specific decisions must be made in order to achieve the specific goals of the developer, and that these specific goals will vary from one implementation to another and from one developer to another. Moreover, such a developmental effort might be complex and time-consuming, but would nevertheless be a routine undertaking of engineering for those of ordinary skill in the art having the benefit of this disclosure.

Throughout the present disclosure, relevant terms are to be understood consistently with their typical meanings established in the relevant art.

Embodiments in the present disclosure may allow a user who has created or is editing a document (e.g., a spreadsheet, word processing document, presentation or other) using a particular application (e.g., a particular spreadsheet program or a web browser) on a particular device (e.g., a desktop computer, laptop computer, smart phone, tablet, TV set top box, gaming console or other device) to create and manage the document as what is described herein as a “multi-cloud document.” A multi-cloud document may consist of multiple copies of a document that reside on any or all of the devices and clouds being used by that user (or by another user with appropriate permissions) but with each copy residing on each device or cloud being synchronized to all others such that in one embodiment, the set of copies of the document may behave effectively as one document. In addition to propagating changes to some or all of the copies of the multi-cloud document, the format and structure (“native structure”) of each copy may be maintained in the format and structure required for the application or applications (“native applications”) that are expected to access each copy of the document.

The set of entities that are of interest—clouds, devices, applications, and documents, etc.—may be viewed as a “mesh” or matrix that represents all of the possible meaningful combinations of these entities. Described herein are systems that interconnect all of these entities. The term “mesh” refers to an implementation of all of the useful interconnections, which may be performed in a transparent fashion. The mesh may consist of several pieces of software running on the user devices and running on a cloud service. These pieces of software all may interact to create a system of sharing and synchronization that is referred to here as simply “the mesh.”

If the user, or another user with appropriate permissions, edits any of the copies of the multi-cloud document on any of the devices or clouds on which a multi-cloud copy resides, the changes resulting from the edit may be propagated to some or all of the other copies of the document on the other clouds and devices. The changes may be propagated in such a way that the native structure of each copy of the document is essentially maintained such that any native applications that may operate on the device or cloud can access the document without any special knowledge of the document. In addition to content, format, and structure, versions and access rights for the multi-cloud document may be maintained across all clouds and devices.

No distinction need be made on the native storage approach of each document. In many document storage systems, documents are stored as files that reside on a hierarchical file structure consisting of “folders” or subdirectories. In other cases, the document is stored as multiple file fragments that are associated to each other. In still other cases, the document is not stored as a file at all but consists of entries in one or more databases that are associated with one another. Embodiments described herein may operate regardless of the native storage approach of the document.

An embodiment of the system may comprise software running both in the devices (“mesh clients”) and in an intermediate cloud (“mesh cloud”). The user may install a mesh client in each device on which he or she wants to create and access multi-cloud documents. Mesh clients so installed may automatically connect to and communicate with the mesh cloud.

Mesh clients can monitor API (application programming interface) activity on the device on which they are loaded. Events that can be monitored include application startup, document create, document open, and reads and writes of the document to local storage. In addition, the volatile memory of native applications that have opted into the mesh may be monitored. The mesh client may capture data that is written by the native application to the application's volatile memory. The mesh client also may observe behavior of the application using d-trace, s-trace, and/or x-trace capabilities of the local operating system, or other tracing functions or facilities provided by the operating system or by the hardware.

The mesh client may report to the mesh cloud the changes made in native application volatile memory that were made by the native application as well as the tracing function information that the mesh client collected. The mesh cloud may use this information to develop the format and structure of the change to the document such that it can be sent to the other mesh clients so that they may properly update the local copy of the document in the correct format.

Edits made by users other than the owner of the document may be controlled by the owner of the document and may be coherently applied to all copies of the multi-cloud document on all registered devices and clouds.

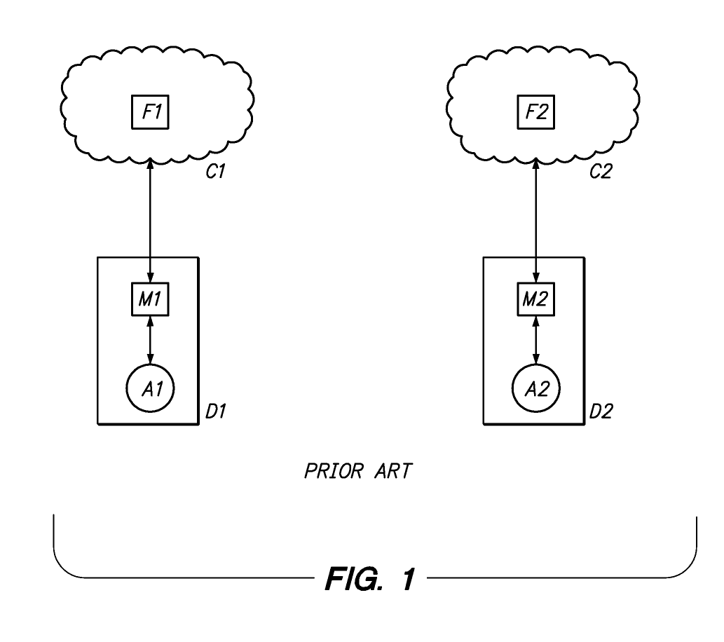

The embodiments described herein represent an improvement over prior systems. FIG. 1 depicts a typical “siloed” cloud configuration as it would appear in prior cloud networks. In this example, a first cloud C1, is connected to a first device D1, which is running a first application A1 that is editing a memory image M1 of the document in memory. D1 is connected to C1 so that any changes in D1 are updated to the copy of the document in C1. A second cloud C2 is connected to a second device D1, which is running a second application A2 that is editing a memory image M2 of the document in memory. As with the first cloud C1, any edits to the document image that are made by A2 cause the copy of the document in C2 to also be updated. The documents on the two devices and stored in the two clouds cannot normally be shared without the user manually doing so either by emailing the documents between the devices or clouds or some other manual file transfer operation.

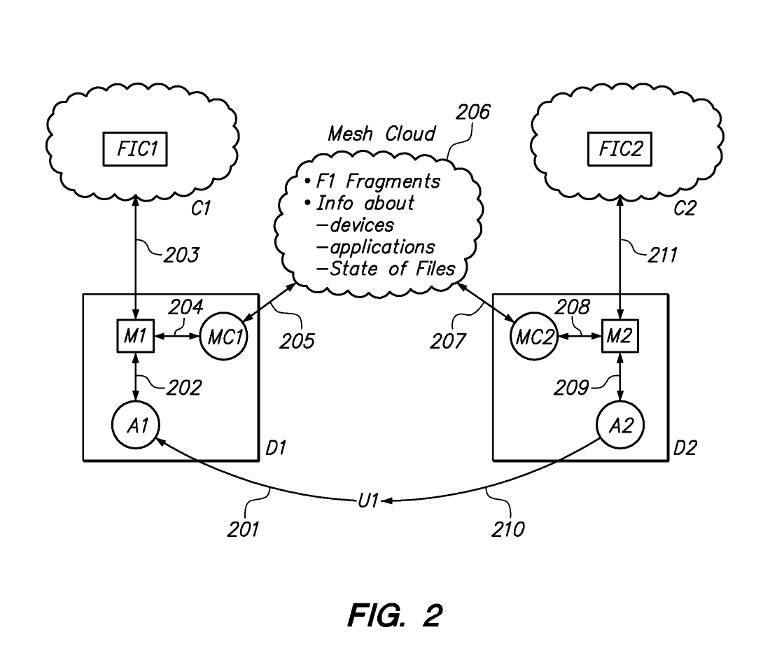

FIG. 2 through FIG. 6 depict a cloud environment in which multiple “siloed” cloud documents have been interconnected by systems described herein, thereby forming a “mesh” among all of the elements shown in the diagrams. In general, the copies of the document stored on the devices and clouds may operate as a single “multi-cloud” document such that any update of any of the copes of the document will result in updates of the other three copies of the document. All of the copies of the document therefore may behave as if they were one document. The mesh clients in the devices may capture changes that occur in that first device, and transmit the changes to the mesh cloud, which may convert them to the correct format for the other devices. The mesh cloud may then transmit them to the mesh client in the other devices, which then may write the changes to the corresponding memory images, and then the user applications on each device may write the changes to the appropriate document stored on the “siloed” cloud server.

Symbols common to these diagram are set forth in the following list:
D1 (Device 1): mobile or stationery computing device such as a phone, tablet, laptop, computer, gaming console, or other that may be used by U1.
D2 (Device 2): mobile or stationery computing device such as a phone, tablet, laptop, computer, gaming console, or other that may be used by U2.
U1 (User 1): a human that may use D1 and D2.
A1 (Application 1): an application running on Device 1 that may perform operations on files located on the device or in a cloud.
A2 (Application 2): a second application running on D2.
MC1 (Mesh Client 1): a piece of software that runs on D1, which may detect changes in M1 and communicate with the mesh cloud server.
MC2 (Mesh Client 2): a piece of software that runs on D2, which may detect changes in M2 and communicate with the mesh cloud server
M1 (Application Memory 1): a working memory region in D1 that is used by A1 to manipulate information including copies of F1
M2 (Application Memory 2): a working memory region in D2 that is used by A2 to manipulate information including copies of F1
C1 (Cloud 1) and C2 (Cloud 2): services that allow Devices and Applications to store and access information, including files, over a network (wireless or wired).
F1 (File 1): a multi-cloud file or document which may be viewed by users as a single file but which may have multiple instances of itself stored on devices or in clouds.
F1C1: an instance of F1 stored in C1.
F1C2: an instance of F1 stored in C2. While the content of F1C1 and F1C2 are conceptually the same as all of other copies of F1, the actual format of F1C1 and F1C2 may be defined by the local requirements of C1 or C2, respectively. For example, F1C1 may be stored as a database and not as a contiguous data file.

FIG. 2 illustrates an embodiment of a write operation by a user U1. In step 201, the user U1 uses A1 to modify a copy of F1 which is in memory on D1. In step 202, this causes A1 to modify the in-memory copy of F1 at M1. In step 203, A1's write to M1 also causes other software loaded in D1 (such as a web browser, a word processor, a spreadsheet program, or other such user application) to write the change to F1C1 at C1. In step 204, the first local mesh client MC1 detects the change in M1 and captures the details of the change according to methods known in the art, or preferably as described herein.

In step 205, MC1 communicates the changes to F1 that were contained in M1 to the Mesh Cloud bypassing the minimum “fragment” of F1 that has changed. MC1 may also pass other metadata to the Mesh Cloud that further describes the change contained in the fragment of F1. In particular, at some point during the connection between MC1 and the Mesh Cloud, MC1 may communicate a possibly unique multi-cloud document identifier that identifies F1. MC1 may also communicate a possibly unique device identifier that tells the Mesh Cloud which device MC1 resides on. The Mesh Cloud may keep track of which Devices and Applications are editing copies of F1. It may keep track of this information using one or more databases. (Reference to a “database” herein may equivalently refer to a single database or multiple databases.) In step 206, therefore, the Mesh Cloud may determine which devices and Mesh Clients need to be updated, and may perform a file format conversion on the file fragment that it received from MC1 in step 205 above. This file format conversion may be any such conversion known in the art, or it may preferably be conversion methods described herein.

The mesh cloud may handle management and synchronization of files across devices and applications by performing the following operations:

1. Upon startup the Mesh Cloud may initialize all previous state information including known devices, applications, files as well as pending file updates.
2. The Mesh Cloud may determine the current state of all devices, applications, and open files and determine which Mesh Clients are operational.
3. The Mesh Cloud may then receive file change updates from all mesh cloud clients in operation. These updates are file fragments with associated metadata. The Mesh Cloud may determine which Mesh Clients in which devices must be updated as a result of the received fragments and metadata, translate the fragments appropriately and send them to the appropriate mesh clients.

In step 207, The Mesh Cloud determines that the copy of F1 at D1 requires an update and transmits the required changes to F1 contained in the fragment that was translated in step 206 above to MC2. In step 208, MC2 receives the edit information (fragment and optional metadata) from MC1 and causes it to be written into the M2 memory region which A2 is using to hold F1 in D1 using techniques known in the art or the inventive techniques described herein. In step 209, A2 detects the change to its memory image. In step 210, A2 displays the changed information to the user U1. In step 211, A2 causes the change to be written to the copy of F1 contained in C2 at F1C2.

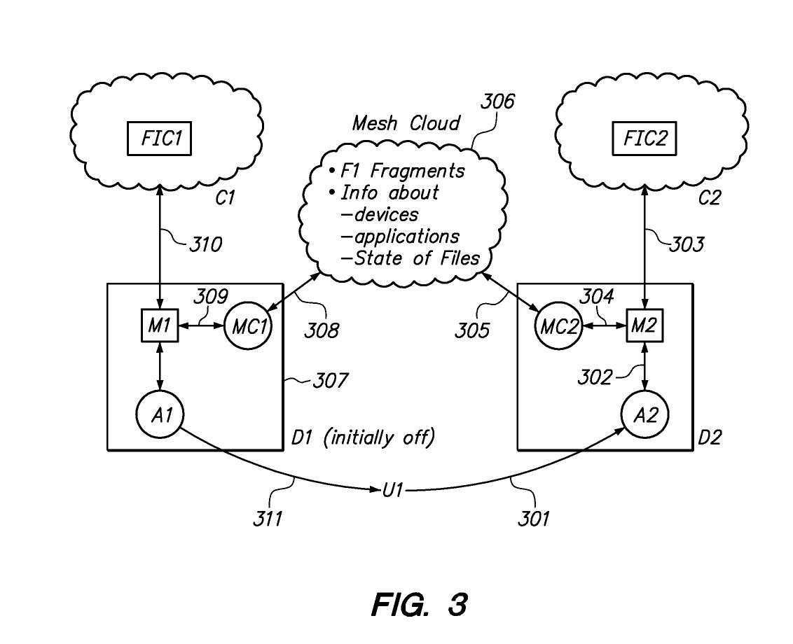

FIG. 3 illustrates an embodiment of a write operation by a mesh cloud user, where one device is initially off. In this example, D1 is initially turned off but the other assets are in operation. In step 301, user U1 edits a file F1 on D2 using A2. This results in the edit being committed to M2 in step 302. In step 303, the edit in step 301 also results in the edit being sent to C2. In step 304, MC2 detects the change in M2. In step 305, MC2 sends the change (which may be a document fragment plus associated metadata) to the Mesh Cloud. In step 306, the Mesh Cloud determines that a copy of F1 is also potentially at D1 and translates the fragment. The Mesh Cloud also determines that D1 is not currently active. It therefore retains the translated fragment until D1 is available (Note that D1 could be turned off as indicated in the diagram but it could also be that D1 is on but A1 is not running or that D1 is on, A1 is running, but A1 does not currently have a copy of F1 in its memory buffer M1.) MC1 in this example is also running in D1.

In step 307, D1 is turned on, A1 begins running, and U1 uses A1 to open an instance of F1. In step 308, the Mesh Cloud detects that D1, A1, and MC1 are running. It transmits the fragment to MC1. In step 309, MC1 updates F1 by injecting the fragment into M1. In step 310, the change to M1 causes A1 to update F1C1 at C1 and, in step 311, to update A1's screen thereby making the change apparent to U1.

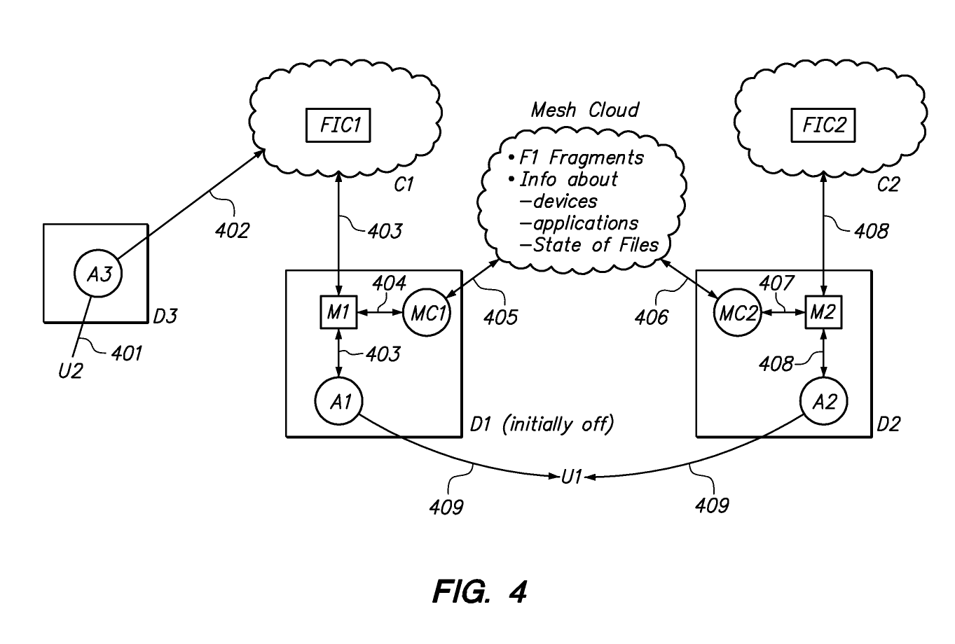

FIG. 4 illustrates an embodiment of a write operation by an outside user U2 who is not using a mesh client. In this embodiment, user U2 is using D3 and is using application A3 to access file F1C1 in C1. In step 401, U2 uses application A3, which in step 402 changes the file instance at F1C1 in C1. In step 403, the change at F1C1 is detected by application A1 running in device D1. The change is reflected in the memory image M1.

In step 404, the change in M1 is detected by MC1, which in step 405 transmits the change fragment (and may transmit metadata) to the Mesh Cloud. The Mesh Cloud may then translate or convert the fragment from one file format to another. In step 406, the Mesh Cloud transmits the change to MC2. In step 407, MC2 then injects the change into the memory region M2, which in step 408 causes A2 to transmit the change to F1C2 at C2. Finally, in step 409, both A1 and A2 may update the screen image of the application making the change visible to U1.

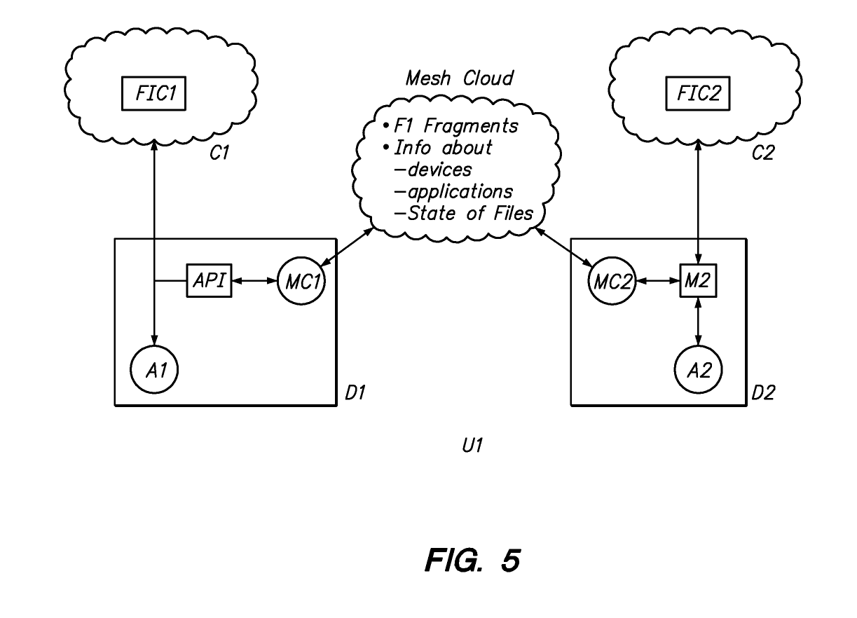

FIG. 5 illustrates an embodiment of a write operation with clients that do not require memory injection. Certain versions of some applications and cloud systems implement an API in the device which would allow the Mesh Client to be able to bypass its normal memory detection and injection process and interact with the API. One implementation that follows this model is Google Docs when running via a Browser on Windows, and connecting to Google's GoogleDrive cloud service. In this circumstance, the system could operate according to any of the embodiments including FIG. 2 through FIG. 4, except that instead of memory injection into M1, MC1 may inject changes into F1C1 directly through the API associated with A1.

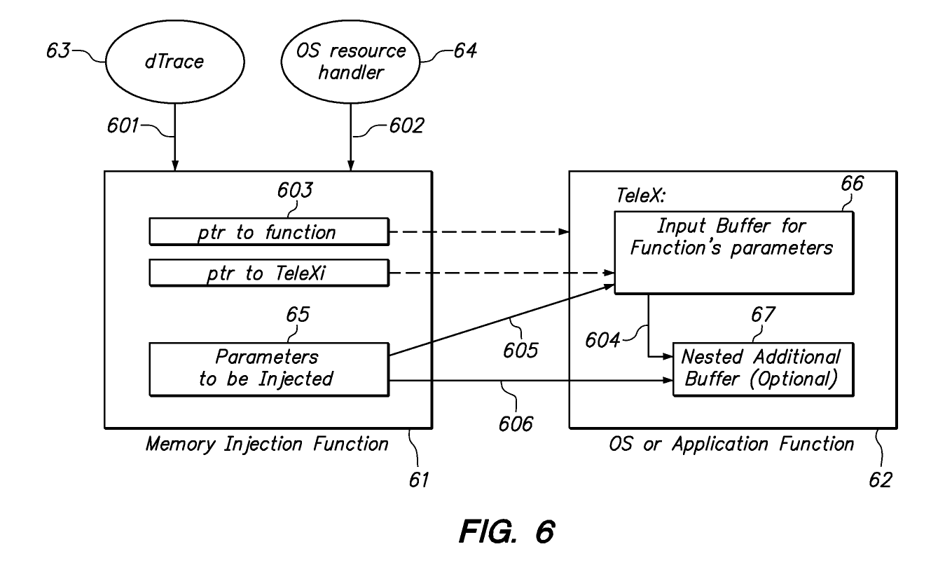

FIG. 6 illustrates a process for injecting parameters into an operating system or application function. In this embodiment, dTrace is used to determine (a) the location of the operating system or application function into which parameters are to be injected, and (b) the memory address of the input buffer for that function's input parameters. It also illustrates how the invention injects parameters into the input buffer. The “memory injection function of the invention” 61 is running as part of an instance of the Mesh Client. Item 62 is the “OS or Application function” into which the parameters are to be injected. The function dTrace 63 is an operating system function that provides information about OS or Application functions running in a Device. The “OS resource handler” 64 is an operating system function that that provides information about resources that exist within the operating system. Function 65 contains the parameters that the Mesh Client will inject into the OS or application function. TeleXi 66 is the parameter input buffer to the OS or application function. The “nested additional buffer” 67 is a location that the invention uses to copy additional parameters if TeleXi is of insufficient size to contain all of the parameters.

When the mesh client needs to inject parameters into an Application running on a Device, it may in one embodiment perform the following steps as illustrated in FIG. 6. The mesh client interrogates dTrace (step 601) and the OS resource handler (step 602) to obtain the pointer to the function (step 603), and the pointer to the input buffer TeleXi. On many platforms, dTrace returns hashed representations of the function names. These hashed representations may be converted into actual function names by calling the OS resource handler. In one embodiment, each of the hashed representations obtained from dTrace may be converted into function names until it finds the function name and address into which it needs to inject the parameters.

The mesh client may determine the size of the buffer TeleXi to ensure it is large enough to hold the parameters at 65. If it is not, the mesh client may obtain an additional buffer from the OS resource handler and nest it to the buffer TeleXi at step 604. In the final step, the mesh client may copy the contents of 65 into TeleXi (step 605) and, if necessary, into the nested buffer (step 606).

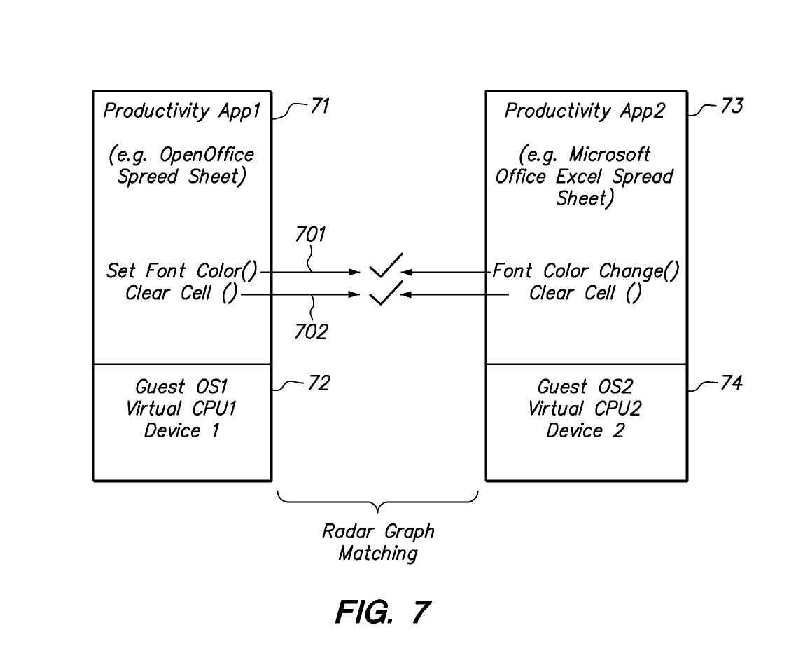

FIG. 7 illustrates an embodiment of matching, mapping, and conversion between different elements of a mesh cloud document as stored within different applications. A mesh cloud server and/or client may determine the mapping/matching of functions between applications that perform a similar function (e.g. spreadsheet, word processing, presentations, or others) but which are actually different applications. A first productivity application 71 is running in a particular first guest operating system, running on a first virtual CPU, and running in a first device 72. This application could be a spreadsheet that is, for example the OpenOffice spreadsheet application. In this embodiment, a second productivity application 73 is running on a second guest operating system, running on a second virtual CPU, and running in a second device 74. This second application could be, for example, the Microsoft Office Excel spreadsheet application.

Thus, in FIG. 7, two applications of similar type (e.g. spreadsheets) but having different authors (e.g. the spreadsheet by OpenOffice and Microsoft Office's Excel spreadsheet) are shown. Both of these spreadsheets perform similar functions and they therefore both possess a similar set of functions that can be used to change their various attributes. For example both spreadsheets have the ability to change the color of a font in one of the spreadsheet cells or to delete the entire contents of a spreadsheet cell.

Although the functions implemented by both spreadsheet applications are similar, the name of the corresponding function on each application is very likely different as is the exact format of information that is passed to each function.

In order for the mesh cloud and/or mesh client to convert attributes from one application to another, it should understand how the functions of one application map into the similar functions of the other. The mesh cloud and/or mesh client therefore may include an application, referred to herein as the Radar Graph Mapping Function, that creates this mapping information and saves it for use by the mesh client and mesh cloud software components.

In FIG. 7 are shown two typical internal functions for each of the two spreadsheet applications 71 and 73. Application 71 possesses two functions (among many others) called SetFontColor( ) and ClearCell( ). Application 73 possesses two functions (among many others) called FontColorChange( ) and DeleteCellValue( ). In one embodiment, the Radar Mapping Matching function performs the following operations to match functions between two similar applications:
1. It uses dTrace to extract the hashed names of all functions used by 71 and 73.
2. It uses OS functions to convert the hashed names into the actual names of the functions.
3. It then compares all of the names from one application with all of the names of the other and attempts to determine which of them perform the same function even though they have different names.
4. As shown in Drawing 4, the Radar Graph Matching function has determined at 701, that the SetFontColor( ) function in 71 should be paired with the FontColorChange( ) function in 73. Further it has determined at 702 that the ClearCell( ) function of 71 should be paired with the DeleteCellValue( ) function of 73.

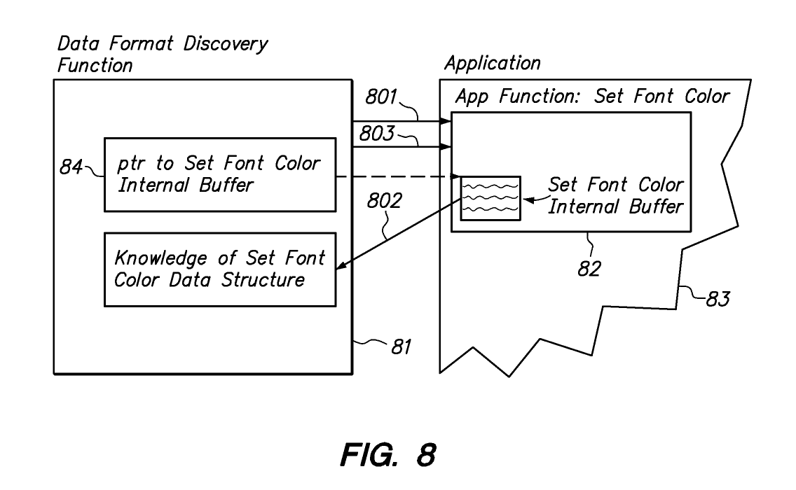

The Radar Graph Matching function may create a catalog of all mappings of all functions between all of the similar apps with which the mesh cloud can operate. This catalog may be used in conjunction with the information obtained as described in FIG. 6 or FIG. 8 by the mesh cloud and/or mesh client to determine how to translate changes from one application to another.

FIG. 8 illustrates an embodiment of the discovery of the internal data format of an application function. A “Data Format Discovery Function” 81 uses a pointer to a specific function 82 in the Application 83 into which the invention will later inject information. It also obtains a pointer 84 to the internal buffer used by the function.

For the mesh client to update an application App2 based on changes that occurred in an application App1 it may perform the following operations:
1. determine the type of the update that has occurred in App1, e.g., a change to a font color in a particular cell of a spreadsheet open by App1. This may be determined by the identity of the function whose memory buffer is updated when the information changes in the App1;
2. determine the corresponding function of App2 that performs this update. This may be done by consulting the catalog of function mappings created as explained in the description accompanying FIG. 7;
3. determine the format of the information that will cause the change to occur in App2, e.g., the format of the information that will cause the application to change the font color; and
4. inject that information into the internal buffer of the correct function of App2.

To perform Steps 3 and 4 above, the Data Format Discovery Function 81 may perform the following steps: In step 801, for each function 82 of App2, it may obtain the address of the function's internal buffer, for example using dTrace as described herein. In step 802 it may then record the contents of the internal buffer of the function. It may then call the App2 function 82 according to its normal calling sequence requesting that it make a change. In step 803, it may then read the new contents of the internal memory buffer and compare it to the original content. It then may call the function again telling it to undo the last operation so that the data in the internal buffer is returned to its prior state.

By comparing the contents of information obtain in steps 802 and 803, above the Data format Discovery Function 81 may determine what the format of the information in the internal buffer is. This may then be used when it writes data to the buffer as explained in the description that accompanies FIG. 6.

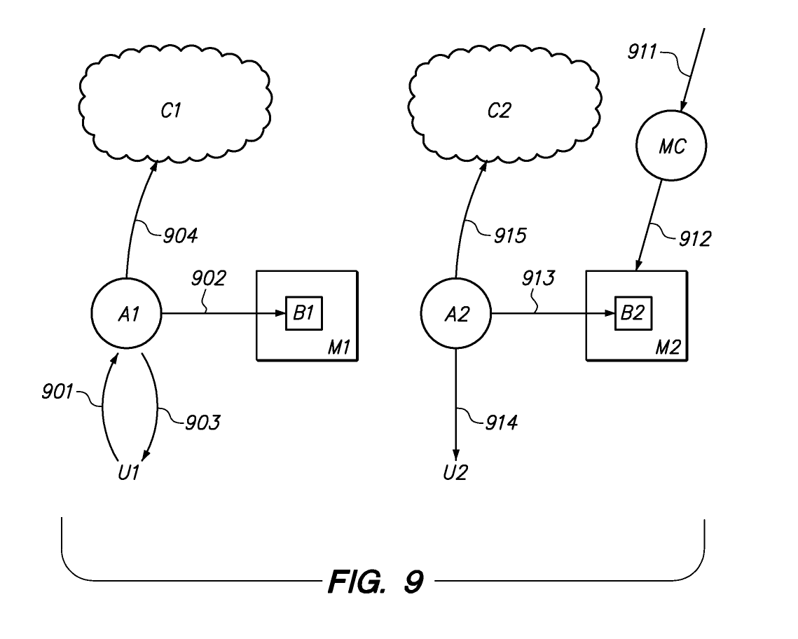

FIG. 9 illustrates an embodiment of memory injection and resulting update to screen or user, cloud, and memory. The left side of FIG. 9 illustrates the operation of an application running in a Device that does not make use of a mesh client. Application A1 runs in the Device, with a file open whose image is contained in M1. In addition, A1 also keeps a copy of the file in the cloud C1 and may in one embodiment ensure that that copy is always synchronized to the copy on the Device.

A1 may communicate to the user U1 by updating the screen, and synchronizes the open file to the cloud C1. It also maintains a copy of the file in its local memory M1. Within M1 is shown a function buffer B1 which is a buffer for input parameters for one of A1's functions. When the user U1 makes a change to a file that the application A1 has open (using a keyboard and mouse, or a touch screen, for example) the following operations may occur: In step 901, the user performs and edit operation on the file. In step 902, A1 updates the image of the file in M1. In step 904, A1 updates the image of the file in the cloud C1. In step 903, A1 may also update the screen of user U1 such that the edit that the user made is reflected on the screen.

The right side of FIG. 9 illustrates an embodiment in which an application A2 is running with the mesh client MC. The operation of the mesh cloud can make use of an expectation that a user application A2 is designed to ensure that the Cloud version of the file is consistent with the image in the application memory M2.

Except for the addition of the mesh client MC, and the operations it performs, the other elements are the same as for the left side of the diagram. When mesh client MC receives an update to the multi-cloud document which application A2 has open on the Device it may cause A2 to update the user U2's screen and the cloud C2 copy of the multi-cloud document through the following steps: In step 911, an update to a portion of the multi-cloud document comes to the mesh client MC from the Mesh Cloud. In step 912, the mesh client MC, using in this embodiment the Radar Graph Mapping described herein, locates the appropriate application function buffer B2 in memory M1, and writes the update to that buffer. In step 913, the application A2 receives the update. In step 914, A2 updates the screen of user U2 such that the update is properly reflected on the screen. Finally, in step 915, A2 updates the instance of the file in cloud C2. In this way, the application A2 accepts the change that came from the Mesh Cloud, and causes application A2 to update the user and the cloud C2 copy of the document.

The sections that follow describe the Mesh Cloud in structural and functional terms. First, a “mesh data plane” is described whose function is to move data from mesh clients, through the mesh cloud, to other mesh clients, and ultimately to the native applications and documents. Second a “mesh control plane” is described that manages non-content related information that needs to be shared between components of the mesh.

### Operation of the Mesh Data Plane

When a native application running on a device that is part of the mesh changes the content of a document, the mesh data plane, which operates across all clients and the mesh cloud, ensures that all the updates occur correctly across all clouds, all devices, all applications, and all platforms.

When an edit of a document occurs on a device that has a mesh client present on it and for which, in one embodiment, the user has opted that document type into the mesh, the mesh client on the device may perform the following operations:

First, the mesh client running on the device where the edit occurs may detect and capture the native application edit to the document:
This mesh client may use d-trace, or s-trace and b-trace functions, the system requirements of the operating system, and other operating system and application function calls information to develop a model of the application's memory image. The mesh client may monitor and replicate the sequencing and structure of the memory image
Cross-checking may be done to ensure that data changes occurring in an application are being transmitted to system-level resources ensuring that a commit has occurred on these edits.
System registries may also be monitored to detect the use of character codes specific to particular languages so that this information can be used to translate content that is saved in different character codes. Because different applications use different approaches to handling various languages, the mesh client may track these data items and synchronize them.
To ensure that the mesh client activities do not produce problems for antivirus mechanisms built into the local operating systems, the mesh client may self-register with memory handlers and as an add-on to applications such as Microsoft Office. The mesh client may also contain ASLR (address space layout randomization) and DEP (data execution prevention) handlers to ensure that the local operating system does not flag volatile memory edits as malware.

Second, the mesh client may report the edit to the document to the mesh cloud. In addition to sending the edit information itself, the mesh client may also report any API (application programming interface) or trace activity associated with the edit.

Third, the mesh cloud may receive and processes the edit information and API activity information reported by the mesh client.
The mesh cloud may be aware of all mesh clients in use by a user (either active or inactive).
The mesh cloud may receive edits and API activity detected and reported by mesh clients.
The mesh cloud may compare the edit information and the API activity to a database of activity relating to that particular application, platform, and document type.
Most of the edit activity may be unambiguously categorized and thereby the semantic, and presentation aspects of the edit activity can be “understood” by the mesh cloud.
Any activity that does not correlate with a known understanding of how the application functions may be analyzed probabilistically to determine how the edit operation matches the native application's resources and presentation. Metadata may be consulted to further enhance the operation of this probabilistic analysis.
Once the edit is understood, the mesh cloud may then make a list of the destination clients to which the edit operation must be sent.
For each destination mesh client, the mesh cloud then may restructure the edit information so that it is appropriate for each mesh client on each destination platform registered by this user (if clients are not running or accessible it queues them for update later).
In general, the mesh cloud in one embodiment does not store the user's data in the cloud except when caching edits that are destined for platforms or applications that are not currently active and connected to the network.
The mesh cloud in one embodiment does persistently store inconsistencies that emerge from the probabilistic correlation process. It also may keep hashes of all documents. These hashes may actually be generated by the mesh clients.

Fourth, each mesh client then may receive the edit information from the mesh cloud:
When an edit is received from the mesh cloud the mesh client may determine if the destination app is running and has the relevant file open.
If the app or doc is not open the client can (a) ask the user to open the app and/or the document and when it is opened perform the write operation described below or (b) not inform the user of the edit and simply wait until the app or document is opened at which time it will perform the write operation described below or (c) automatically open the app and/or document and perform the write operation. This may be configurable.
Once the correct application is running with the file open:
   The mesh client may determine how the native application updates its image with the type of information contained in the edit information. It can do this by monitoring the system calls made by the native application. The mesh client thereby “knows” how the native application updates its memory image with the type of edit that the mesh client has received from the mesh cloud. The mesh client then may present the edit information to functions associated with the application such that those functions will cause the memory image to be updated appropriately. In addition to content, rendering information may also be passed to the application in this fashion.
   The mesh client can detect if the application currently has the memory image of the document locked and may wait until it is unlocked to cause any edits to it to be performed.
If the relevant app is not running with the associated document open, the mesh client may cache the edit until the application and document are opened. The mesh cloud may also keep the change until it gets confirmation from the mesh client(s) that the change has been successfully written.
When a mesh client first begins running in a device, it can query the mesh cloud to determine if there are any edits available pending in the mesh cloud. If so, it may operate according to the logic described above to write those updates to the correct documents.

### Operation of the Mesh Control Plane

The mesh “control plane” may be designed to handle version control, edits from multiple platforms, edits from non-owners and access control between users.
The mesh may allow non-owners to read or even write to other user's multi-cloud documents with the owner's permission.
The owner of a document may control the rights given to others. These rights might for example include:
   read-only privilege—all write operations by non-owners are prohibited;
   write-with-permission—allow write by a non-owner only if explicit acceptance of the write operation is granted by the document owner; or
   full write privilege—the non-owner can write to the document at any time.
The access rights may be specified by the owner of the document and may be saved by the mesh system.
LDAP (Lightweight Directory Access Protocol) and Kerberos identity information can also be optionally incorporated into the mesh system. This may allow file/document access rights from the directory services to be compared to access permissions that an owner may grant to users using the mesh and permit those access rights to be respected or over-ridden according to policies set by a system administrator.
The system can optionally put a “DNS fence” (Domain Name System) around a user. This allows the mesh to prevent sensitive corporate data from being pushed to inappropriate domains.
If the mesh client detects that a non-owner of a document is attempting a write request that is restricted, it may direct the request to the mesh cloud which then may queries the owner, so that:
   the owner accepts or rejects the edit; and
   the mesh cloud then informs mesh client, and the non-owner, of the access decision.
The mesh control plane may also detect the version of applications, operating systems, and clouds that the user is using and make sure the user updates the mesh client software to be compatible with that update.

Exemplary embodiments have been described with reference to specific configurations. The foregoing description of specific embodiments and examples of the invention have been presented for the purpose of illustration and description only, and although the invention has been illustrated by certain of the preceding examples, it is not to be construed as being limited thereby.

What is claimed is:

1. A method comprising:
detecting, within a first computer process in a multitasking environment, one or more first changes in a first data structure stored in a first digital storage medium which is part of a first digital device; wherein the first data structure comprises at least a portion of a first user-editable document corresponding to a multi-cloud document identifier; wherein the one or more first changes are made within a second computer process which is different from the first computer process; and wherein the first digital device further comprises a data transmitter in connection via a network with a mesh cloud server; and
sending (A) the multi-cloud document identifier and (B) a first representation of the one or more first changes, to the mesh cloud server via the data transmitter over the network; wherein the mesh cloud server comprises a computer processor, a data receiver configured to receive the first representation, an intermediary digital storage medium, and a database comprising one or more records linking the multi-cloud document to unique identifiers of one or more user-editable documents including the first user-editable document.

2. The method of claim 1, further comprising:
running a mesh client application, within the first computer process, which performs the step of detecting; and
running a user application, within the second computer process, which causes the one or more first changes in response to input from a user via a user interface.

3. The method of claim 2, wherein the mesh cloud server further comprises a registration database comprising one or more records linking the user with (A) a set of one or more mesh client applications including said mesh client applications, and (B) a set of one or more multi-cloud document identifiers including said multi-cloud document identifier.

4. The method of claim 1, wherein the first user-editable document, both before and after the one or more first changes, conforms to a first predefined document format.

5. The method of claim 1, wherein the database comprises a first record linking the multi-cloud document identifier with a unique identifier of the first user-editable document, and a second record linking the multi-cloud document identifier to a unique identifier of a second user-editable document; and wherein the mesh cloud server further comprises means for converting the first representation into a second representation of one or more second changes to be made in a second data structure which comprises at least a portion of the second user-editable document.

6. The method of claim 5, wherein the second user-editable document, both before and after the one or more second changes, conforms to a second predefined document format.

7. The method of claim 1, wherein the first digital device further comprises a data receiver in connection via a network with a cloud server storing the first user-editable document, further comprising:
receiving from the cloud server, via the data receiver, the first data structure prior to the one or more first changes.

8. A digital device comprising:
a processor;
a multitasking operating system;
a data transmitter in connection via a network with a mesh cloud server;
a first digital storage medium;
means for detecting, within a first computer process, one or more first changes in a first data structure stored in the first digital storage medium, wherein the first data structure comprises at least a portion of a first user-editable document corresponding to a multi-cloud document identifier; wherein the one or more first changes are made within a second computer process which is different from the first computer process; and
means for sending (A) the multi-cloud document identifier and (B) a first representation of the one or more first changes, to the mesh cloud server via the data transmitter over the network; wherein the mesh cloud server comprises a computer processor, a data receiver configured to receive the first representation, an intermediary digital storage medium, and a database comprising one or more records linking the multi-cloud document identifier to one or more user-editable documents which includes at least the first user-editable document.

9. The digital device of claim 8, further comprising:
a user interface;
a mesh client application, configured to run within the first computer process and to perform the step of detecting; and
a user application, configured to run within the second computer process, and to causes the one or more first changes in response to input from a user via the user interface.

10. The digital device of 9, wherein the mesh cloud server further comprises a registration database comprising one or more records linking the user with (A) a set of one or more mesh client applications including said mesh client applications, and (B) a set of one or more multi-cloud document identifiers including said multi-cloud document identifier.

11. The digital device of claim 8, wherein the first user-editable document, both before and after the one or more first changes, conforms to a first predefined document format.

12. The digital device of claim 8, wherein the database further comprises a first record linking the multi-cloud document identifier with the first user-editable document, and a second record linking the multi-cloud document identifier to a second user-editable document; and wherein the mesh cloud server further comprises means for converting the first representation into a second representation of one or more second changes to be made in a second data structure which comprises at least a portion of the second user-editable document.

13. The digital device of claim 12, wherein the second user-editable document, both before and after the one or more second changes, conforms to a second predefined document format.

14. The digital device of claim 8, further comprising a data receiver in connection via a network with a cloud server storing the first user-editable document, further comprising:
means for receiving from the cloud server, via the data receiver, the first data structure prior to the one or more first changes.

15. A method comprising:
receiving, in a transmission over a network from a first digital device to a mesh cloud server, (A) a multi-cloud document identifier and (B) a first representation of one or more first changes in a first data structure stored in a first digital storage medium which is part of the first digital device, wherein the first data structure comprises at least a portion of a first user-editable document corresponding to the multi-cloud document identifier, and wherein the mesh cloud server comprises:
a first database record linking the multi-cloud document identifier to a unique identifier of the first user-editable document;
a second database record linking the multi-cloud document identifier to a unique identifier of a second user-editable document;
converting the first representation into a second representation of one or more second changes to be made in a second data structure which comprises at least a portion of the second user-editable document; and
sending the second representation to a second digital device comprising a second digital storage medium that comprises the second data structure.

16. The method of claim 15, wherein the mesh cloud server further comprises a registration database comprising one or more records linking the user with (A) a set of one or more mesh client applications including said mesh client applications, and (B) a set of one or more multi-cloud document identifiers including said multi-cloud document identifier.

17. The method of claim 15, wherein the first user-editable document, both before and after the one or more first changes, conforms to a first predefined document format, and wherein the second user-editable document, both before and after the one or more second changes, conforms to a second predefined document format.

18. The method of claim 15, wherein the first digital device further comprises a data receiver in connection via a network with a cloud server storing the first user-editable document, further comprising:
receiving from the cloud server, via the data receiver, the first data structure prior to the one or more first changes.

19. A mesh cloud server comprising:
a processor;
a data receiver in connection via a network with a first digital device comprising a first digital storage medium comprising a first data structure comprising at least a portion of a first user-editable document corresponding to a multi-cloud document identifier;
a data transmitter in connection via a network with a second digital device comprising a second digital storage medium that comprises a second data structure;
means for receiving, via the data receiver from the first digital device, (A) the multi-cloud document identifier and (B) a first representation of one or more first changes in the first data structure;
a first database record linking the multi-cloud document identifier to a unique identifier of the first user-editable document;
a second database record linking the multi-cloud document identifier to a unique identifier of a second user-editable document;
means for converting the first representation into a second representation of one or more second changes to be made in the second data structure which comprises at least a portion of the second user-editable document; and
means for transmitting, via the data transmitter, the second representation to the second digital device.

20. The mesh cloud server of claim 19, further comprising a registration database comprising one or more records linking the user with (A) a set of one or more mesh client applications including said mesh client applications, and (B) a set of one or more multi-cloud document identifiers including said multi-cloud document identifier.

21. The mesh cloud server of claim 19, wherein the first user-editable document, both before and after the one or more first changes, conforms to a first predefined document format, and wherein the second user-editable document, both before and after the one or more second changes, conforms to a second predefined document format.

22. The mesh cloud server of claim 19, wherein the first digital device further comprises a data receiver in connection via a network with a cloud server storing the first user-editable document, further comprising:
receiving from the cloud server, via the data receiver, the first data structure prior to the one or more first changes.

23. A method performed by a mesh client application on a digital device comprising a processor, a digital storage medium, a multitasking operating system, and a running user application which is capable of editing a first document, comprising:
obtaining a pointer to a target function and a pointer to the input buffer of the target function using a tracing function provided by the operating system, wherein the target function, when called, changes the content and/or format of a portion of the first document; and
copying one or more parameters to the input buffer, wherein the one or more parameters reflect one or more content and/or format changes in a corresponding portion of a second document.
